(19) United States
(12) Patent Application Publication
(10) Pub. No.: US 2007/0166586 A1
(43) Pub. Date: Jul. 19, 2007

(54) PASSIVE-PUMPING LIQUID FEED FUEL CELL SYSTEM

(76) Inventors: Kevin Marchand, Vancouver (CA); Nimesh Patel, Surrey (CA); Minh Tran, Vancouver (CA)

Correspondence Address: MCANDREWS HELD & MALLOY, LTD, 500 WEST MADISON STREET, SUITE 3400, CHICAGO, IL, 60661, US

(21) Appl. No.: 11/617,933

(22) Filed: Dec. 29, 2006

Related U.S. Application Data
(60) Provisional application No. 60/755,483, filed on Dec. 30, 2005.

(51) Int. Cl. H01M 8/04; H01M 8/24

(52) U.S. Cl. 429/25; 429/34; 429/38

(57) ABSTRACT

A passive-pumping liquid feed fuel cell system includes a cartridge module, a fuel delivery module, a fuel cell module and an exhaust module. In fuel delivery mode, a bladder in the cartridge module is passively pressurized by permeable gas separated from liquid fuel to a pressure greater than fuel cell pressure, and doses are delivered to the fuel cell by controlling a single fuel valve. In fuel return mode, unused liquid fuel is separated in the exhaust module while the fuel cell is operated in a temporary high load mode, thereby generating anode gas pressure greater than bladder pressure and transferring unused fuel back to the bladder. The returned fuel maintains bladder volume and internal pressure for ongoing fuel dosing. The system provides compact and efficient micro-dose operation of low power formic acid fuel cells, and is operable with highly concentrated stored fuel and resulting high energy capacity.

### CROSS-REFERENCE TO RELATED APPLICATION(S)

This application relates to and claims priority benefits from U.S. Provisional Patent Application Ser. No. 60/755,483, filed Dec. 30, 2005, entitled “Passive-Pumping Liquid Feed Fuel Cell System”. The '483 provisional application is hereby incorporated by reference herein in its entirety.

### FIELD OF THE INVENTION

The present invention relates generally to direct liquid fuel cell systems. More particularly the invention relates to passive fuel delivery and handling for a liquid fuel cell system with a pressure-maintaining fuel cartridge.

### BACKGROUND OF THE INVENTION

Fuel cells are electrochemical cells in which a free energy change resulting from a fuel oxidation reaction is converted into electrical energy. Organic fuel cells are a useful alternative in many applications to hydrogen fuel cells, overcoming the difficulties of storing and handling hydrogen gas. In an organic fuel cell, an organic fuel such as methanol is oxidized to carbon dioxide at an anode, while air or oxygen is simultaneously reduced to water at a cathode. Organic/air fuel cells have the advantage of operating with a liquid organic fuel. While methanol and other alcohols are typical fuels of choice for direct feed fuel cells, recent advances presented in U.S. Patent Application Publication Nos. 2003/0198852 (“the '852 publication) and 2004/0114418 (“the '418 publication”) disclose formic acid fuel cells with favorably high power densities and output currents. Exemplary power densities of 15 mW/cm2 and greater were achieved at low operating temperatures, thereby demonstrating the viability of formic acid fuel cells as compact electric power generation devices.

Fuel cell technology is evolving rapidly as an energy supply for portable electronic devices such as laptop computers and cellular telephones. However, mobile devices and other low power applications require a method to substantially continuously supply fuel to the fuel cells, and as well as a method to replenish the fuel once it becomes depleted. A common method for supplying fuel is to encase the fuel in a closed, pressurized cartridge that is removable and replaceable within the electronic device to be powered. It is therefore desirable for the fuel cell to operate at high power densities and for the stored fuel to have a high latent power density. Accordingly, there is a need to be able to store a relatively high concentration of the fuel to be fed to and consumed by the fuel cell(s). For certain vaporizable organic fuels such as formic acid, storing highly concentrated fuel solutions typically results in problematic fuel vaporization during storage and at typical operating temperature ranges. As a result, low concentrations of the vaporizable fuel are typically employed, thereby limiting stored energy density of the fuel to be fed to the fuel cell(s).

Problems also exist with current methods of operating a fuel cell system in which the fuel fed to the fuel cells is delivered from a closed pressurized container during fuel cell operation, and in which the flow of fuel should stop positively when not required for fuel cell operation. Operating such system involves the employment of many system components, thereby increasing the size, volume and complexity of such systems and reduced system efficiencies because of a resulting increase in parasitic power drawn from the system by a multiplicity of system components. System simplification to reduce the number, size, volume and complexity of system components, as well as reduction in the amount of parasitic power drawn from the system, can be accomplished by reducing the number and complexity of active components within the system. Making such a system perform effectively, with minimal components, requires careful integration of system components and functions over a range of operating conditions.

In general, unidirectional flow of fuel from a container with a fuel compressed to moderate pressures cannot deliver fuel to the fuel cell system in an effective manner. As the fuel is discharged from the container, a vacuum would eventually be created within the container, and remaining fuel would become undeliverable. Additionally, fuel recycling is desirable in fuel cell systems in which un-reacted fuel would be wasted if not returned to its storage container. In the case of reactive fuels such as formic acid, the un-reacted fuel and vapor is desired to be contained or converted to benign byproducts for release to the environment.

The present system design incorporates solutions to the foregoing problems of storing, delivering and recovering liquid fuel to be fed to direct liquid feed fuel cells in a low power range suitable for portable electronic devices such as laptop computers and cellular telephones. Unlike direct methanol fuel cells, the present system is designed to accommodate a vaporizable fuel such as an aqueous formic acid solution by providing for the out-gassing of vaporous fuel.

Specifically for fuel delivery from a cartridge, there is a range of solutions to the problems of providing a fuel storage cartridge for delivering fuel to a fuel cell in a low power range suitable for mobile end-uses. These solutions have typically been designed for methanol-based fuel, which in comparison to a liquid fuel such as formic acid fuel, has no requirements for out gassing relief of evaporating vapors, particularly during periods of storage.

Typically, cartridges include housing, a fuel bladder or liner in the housing and a fuel port coupled to the bladder for refueling and fueling. There is a common problem of how to most effectively and efficiently extract or deliver fuel from the cartridge to the fuel cell system while reducing overall system complexity and avoiding additional problems, and increasing effective stored energy density by reducing additional space taken up by the cartridge.

Known solutions belong to the following groups, movable springs, expandable bladders, external or internal powered fuel pumps, wicking fuel ports, and interaction of multiple cavities or bladders.

The most common form of active pumped cartridge employs a movable spring, spring biased plate or wall to push on the liner or bladder and continue to provide pressure as the volume of fuel decreases in the bladder. For example, U.S. Patent Application Publication Nos. 2003/0129464 and 2004/0072049 describe spring and plate mechanisms. U.S. Pat. No. 6,924,054 and PCT/International Publication No. WO 03/043112 describes movable barriers with a spring. Cartridges employing mechanical springs again restrict the space utilization and stored energy density. Further they are mainly suited for end-uses where bladder volume decreases with fuel delivery and a compressive force is required to maintain fuel pressure.

Expandable bladders are disclosed in U.S. Patent Application Publication Nos. 2004/0013927 and 2002/0197522, along with expandable pressure members that provide a positive pressure on the bladder. The expandable bladder disclosed is impermeable to the methanol fuel. An example of the pressure member is compressible foam butted against the bladder. Limitations of this design are (a) that the extra space of the compressible foam limits stored energy density (the volume of the bladder and foam are approximately equal), and (b) that the design is unsuitable for formic acid fuel as the fuel vapor is not managed or relieved.

Actively pumping the fuel out of the cartridge is commonly done, but requires extra components. Pumps can be employed to pump gas back into the cartridge to pressurize the bladder as described in U.S. Patent Application Publication No. 2005/0058858 in which air is pumped back into the cartridge cavity through a second port for maintaining pressure as the bladder volume decreases. Relying only on fuel pumps reduces overall system energy efficiency due to the extra power drain.

A common design for passive fuel delivery is providing wicks coupled between the liner and the fuel inlet, acting by capillary action to transfer fuel. U.S. Pat. No. 6,726,470 and U.S. Patent Application Publication No. 2004/0126643 are representative of wick fuel delivery. Problems with wicking systems include material incompatibility with formic acid fuel, and suitable control of fuel delivery rate. Particularly for low power systems where the fuel dose is small and requires precise control, wicking delivery is not suited.

Multiple cavities or bladders can be employed for pressure management and containing waste fuel. For example, U.S. Patent Application Publication No. 2003/0082427 describes a dual bladder cartridge with one of the bladders having an internal biased spring to pressurize the primary fuel bladder, and two ports for delivering fuel and receiving waste products. The cartridge is additionally complex and costly due to the extra components and less than optimal for storage energy density. In particular the waste product is not reused in this case.

Due to the hazardous characteristic of formic acid, it is a requirement that not more than very low levels of formic acid or vapors are released from the cartridge, known hot swappable liquid fuel cartridges are primarily designed for methanol fuel not formic acid. Methanol fuel storage does not have the same problems of generated gas bubbles that can enter the fuel delivery line and interrupt fuel delivery in various orientations. In particular, there is a no solution for a cartridge and fuel cell system for formic acid that can supply and handle fuel and be operable over a wide range of orientations, without adverse emissions or change in operations.

There is thus a need for a fuel cartridge and matching fuel cell system, that is well-suited to vaporizable liquid fuels such as formic acid, that has a design for pressurizing and delivering vaporizable liquid fuel without powered or movable components, and that is suitable for safely storing formic acid, having a single cavity enclosure for high energy density, recycles depleted fuel from the fuel cell system, and meets safe emissions, and enables an associated fuel cell system to operate with limited movable parts.

### SUMMARY OF THE INVENTION

A passive-pumping liquid feed fuel cell system comprises:
(a) a cartridge module comprising:
   (1) a distensible bladder for containing a liquid fuel;
   (2) an inlet/outlet port fluidly connected to the bladder for intermittently discharging and admitting a pressurized fuel stream from and to the bladder;
   (3) an outlet for discharging an exhaust gas stream from the cartridge module;
(b) a fuel delivery module comprising:
   (1) an inlet/outlet port for intermittently admitting and discharging the pressurized fuel stream to and from the fuel delivery module, respectively, the fuel delivery module inlet/outlet port capable of cooperating with the cartridge module inlet/outlet port to inhibit leakage of the intermittently admitted and discharged pressurized fuel stream;
   (2) a fuel delivery module outlet for discharging at least a portion of the pressurized fuel stream from the fuel delivery module;
   (3) a pressurized fuel stream conduit interconnecting the fuel delivery module inlet/outlet port and the fuel delivery module outlet, the pressurized fuel stream conduit having a flow regulating mechanism interposed therein for allowing flow in the pressurized fuel stream conduit when the flow regulating mechanism is in an open position and inhibiting flow in the pressurized fuel stream conduit when the flow regulating mechanism is in a closed position;
   (4) a recycle fuel stream conduit for directing a recycle fuel stream from a fuel delivery module recycle fuel stream inlet to the pressurized fuel stream conduit at a junction located between the fuel delivery module fuel stream port and the flow regulating mechanism, the recycle fuel stream conduit having a pressure-activated mechanism disposed therein for inducing flow between the recycle fuel stream inlet and the junction;
(c) a fuel cell module comprising at least one electrochemical fuel cell comprising:
   (1) an anode fluidly connected to the fuel delivery module outlet, the anode promoting electrocatalytic conversion of at least a portion of the pressurized fuel stream to cations and an anode exhaust stream, the anode exhaust stream comprising un-reacted fuel stream constituents, if any, and anode reaction products;
   (2) a cathode for promoting electrocatalytic reaction of the cations with an oxidant stream directed to the cathode, the cathode electrically connected to the anode via a circuit comprising an electrical load, whereby electrons are drawn from the anode to the cathode via the circuit and a cathode exhaust stream is produced;
   (3) a cation exchange membrane interposed between the anode and the cathode;
(d) an exhaust module comprising:
   (1) an exhaust module inlet for receiving the anode exhaust stream;
   (2) an exhaust module outlet fluidly connected to the fuel delivery module recycle fuel stream inlet;
   (3) a gas-liquid separator interposed between the exhaust module inlet and the exhaust module outlet, the separator comprising:
      (i) a first chamber comprising an inlet for admitting the anode exhaust stream into the first chamber and an outlet for discharging the recycle fuel stream from the first chamber to the fuel delivery module recycle fuel stream inlet,
      (ii) a second chamber comprising an exhaust module outlet for discharging a gaseous exhaust stream comprising at least some of the un-reacted fuel stream constituents, if any, and at least some of the anode reaction products, and
      (iii) a gas-liquid separator membrane interposed between the first chamber and the second chamber, the separator membrane capable of allowing diffusion of at least a portion of the gaseous exhaust stream constituents from the first chamber to the second chamber.

In operation, when the fuel delivery module flow regulating mechanism is in an open position, the pressurized fuel stream is discharged from the cartridge module, and when the fuel delivery module flow regulating mechanism is in a closed position, the recycle fuel stream is admitted into the cartridge module.

### BRIEF DESCRIPTION OF THE DRAWING(S)

FIG. 1, which is a composite of FIGS. 1A and 1B, as indicated, is a schematic flow diagram an embodiment of the present electric power generation system incorporating one or more liquid feed fuel cells, in which a passive pressurized cartridge is employed to deliver a dosed quantity of liquid fuel to the fuel cell anode(s).

FIG. 2A is a perspective view of the fuel cell system cartridge receptacle. FIG. 2B is a top view of a passive pressurized cartridge. FIG. 2C is a side cross-sectional view a passive pressurized cartridge taken in the direction of arrows CC-CC in FIG. 2B. FIG. 2D is a front cross-sectional view a passive pressurized cartridge taken in the direction of arrows DD-DD in FIG. 2B.

FIG. 3 is a flowchart of the method of gas return to the passive pressurized cartridge.

FIG. 4 is a flowchart of the method of unused liquid fuel returned to the passive pressurized cartridge.

### DETAILED DESCRIPTION OF PREFERRED EMBODIMENT(S)

A solution is provided to at least some of the problems previously described, by combining a passively pressurized fuel cartridge having a fuel management port interface with a fuel cell system with closed fuel circulation, the combination managing the resulting unused fuel and vapor byproducts during fuel cell operation. Such a system is particularly advantageous with aqueous formic acid fuel, where the low flashpoint results in vapors at normal storage and operating temperatures, and unused fuel and by-products are unsuited for release into the user environment, particularly for handheld mobile device applications.

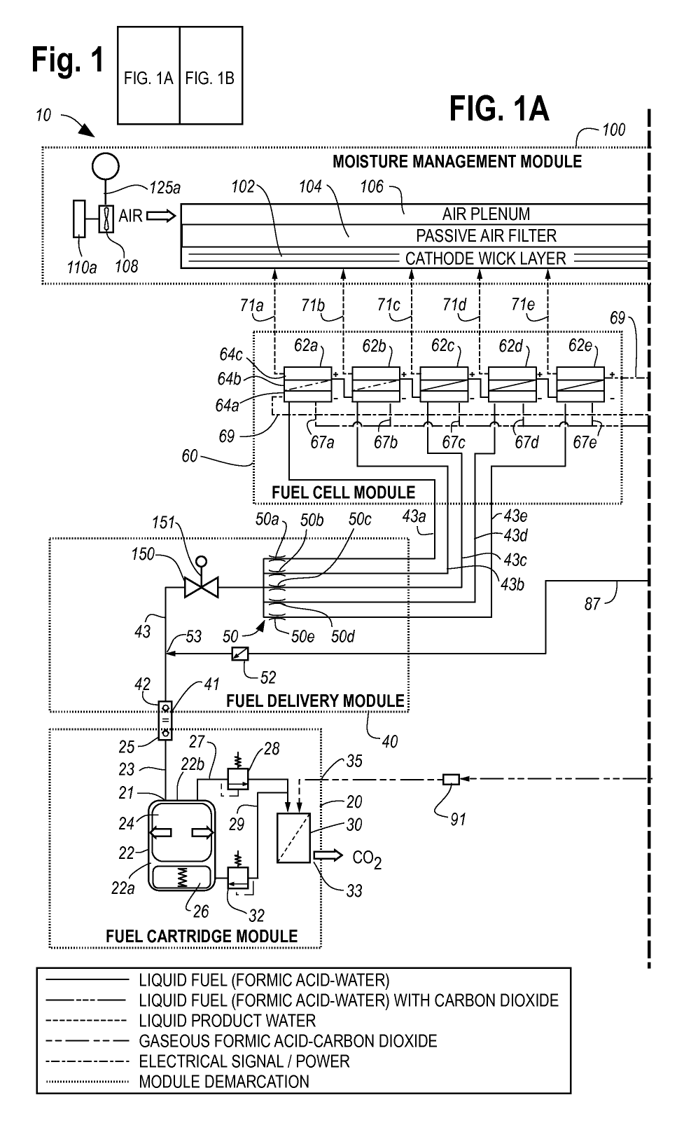

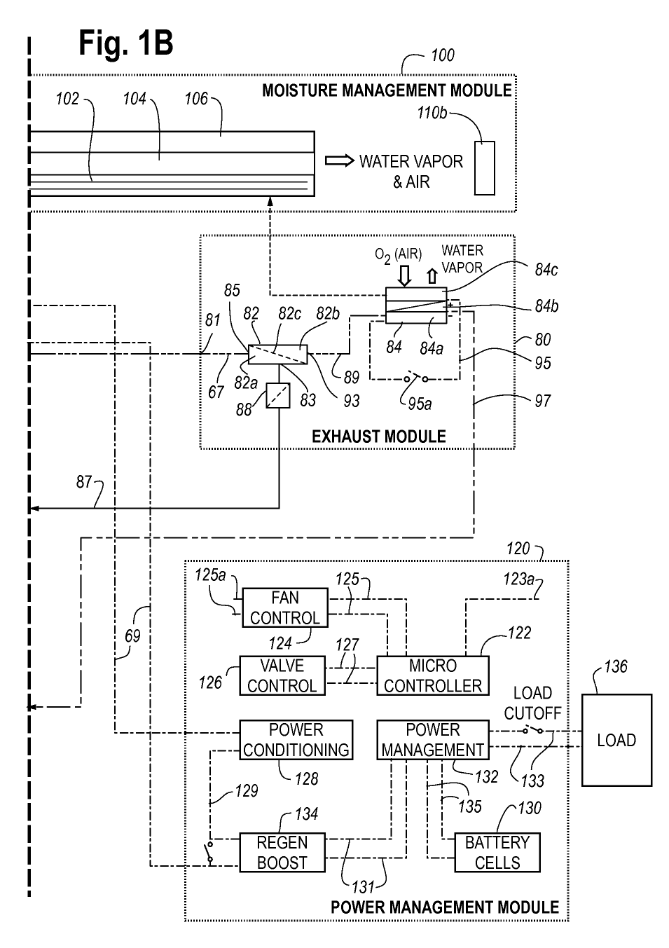

Turning to FIG. 1, an embodiment of the present electric power generation system 10, which incorporates one or more liquid feed fuel cells, is depicted schematically. System 10 includes a removable and replaceable fuel cartridge module 20 for storing, delivering and receiving a vaporizable liquid fuel such as, for example, liquid formic acid. A fuel delivery module 40 accepts liquid fuel from fuel cartridge module 20 and directs a liquid fuel stream to a fuel cell module 60, in which one or more fuel cells generate electric power. An exhaust module 80 processes the anode exhaust stream fuel cell, including un-reacted liquid fuel, as well as vaporous fuel and anode reaction byproducts, and directs a recycle liquid fuel stream back to fuel delivery module 40 after removing vaporous fuel in a gas-liquid separator. An optional moisture management module 100 draws accumulated cathode product water away from fuel cell module 40 and from the vapor cell incorporated in exhaust module 80. A power management module 120 manages the operation of system 10, and in particular regulates the charging of battery cells interposed between fuel cell module 40 and the electrical load to be driven by system 10. Power management module 120 also effectuates operational changes in fuel delivery module 40, fuel cell module 60, exhaust module 80 and/or moisture management module 100 in response to changes in fuel cell performance.

Fuel Cartridge Module

As shown in FIG. 1, fuel cartridge module 20 includes a cartridge housing 22 having an interior cavity 22a and an exterior surface 22b. A cartridge liquid fuel stream port 21 is encompassed by housing exterior surface 22b and has a sealable valve 25, which accommodates bidirectional flow of liquid fuel stream 23 into and out of cartridge module 20. A flexible bladder 24 disposed within housing interior cavity 22a is capable of storing, delivering and receiving a liquid fuel stream 23. A compression mechanism 26, shown as being spring-actuated imparts at least a minimal positive fluid pressure to bladder 24. The compression mechanism includes a first minimum pressure from an elastic member encircling the flexible bladder, and a second pressure from vapors escaped from the bladder and trapped in the cartridge. Preferably, the bladder volume is maintained at about 90% of the interior cavity by returning unused fuel, which has a higher water concentration following reaction of the fuel. The use of aqueous formic acid solution thus enables this dilute unused fuel to be returned to the bladder to maintain volume in the bladder, without which the stored fuel pressure would substantially drop, requiring an active form of delivery. A pressure relief valve 28 discharges a gaseous stream 27 from cartridge housing 22 at a set pressure, to provide a safety factor. A vacuum relief valve 32 draws a gaseous stream 29 into housing interior cavity 22a to inhibit formation of a vacuum within cartridge housing 22. Preferably, the pressure relief valve and vacuum relief valves are integrated into one valve, as known in the gas storage industry.

As further illustrated in FIG. 1, cartridge module 20 further includes a gaseous stream outlet 33 and a gaseous stream filter 30 interposed between pressure relief valve 28 and gaseous stream outlet 33. Discharged gaseous stream 27 is passed through filter 30 to trap contaminants present in discharged gaseous stream 27. Cartridge module 20 also includes an inlet 35 fluidly connected to a fuel cell outlet vapor stream 89, and as shown in FIG. 1, gaseous stream filter 30 is also interposed between cartridge module inlet 35 and gaseous stream outlet 33. As explained in more detail below in connection with fuel cell module 60 and exhaust module 80, fuel cell outlet vapor stream 89 is passed through filter 30 to trap contaminants present in fuel cell outlet vapor stream 89. Gaseous stream filter 30 preferably comprises activated charcoal, but can also include or be made up of materials suitable for trapping vaporous formic acid and other organic fuel stream contaminants like carbon monoxide.

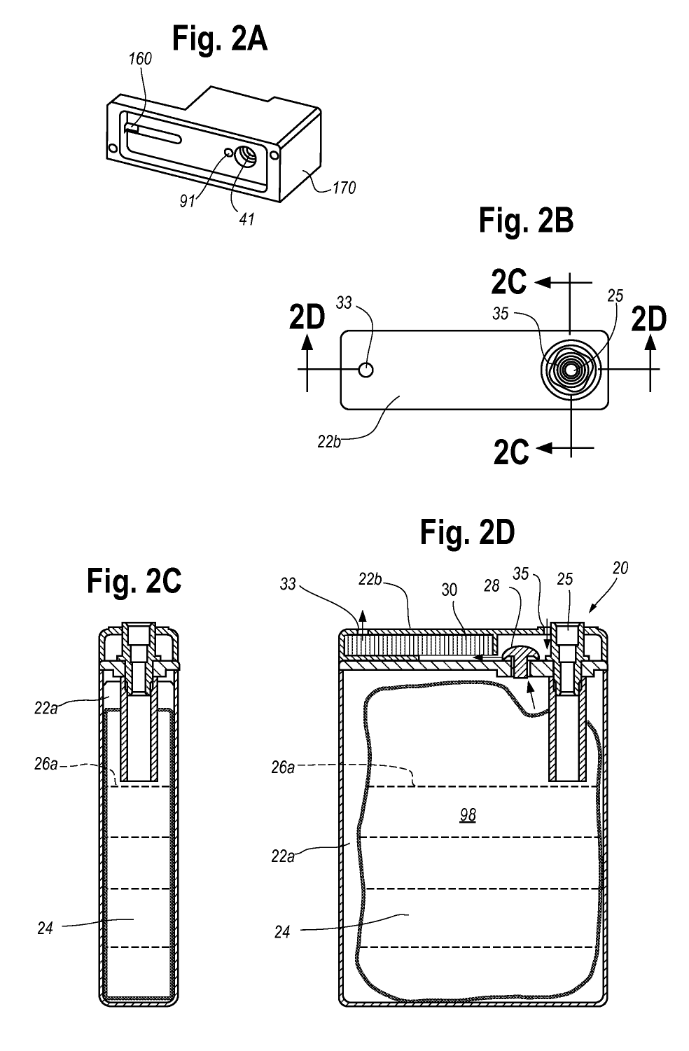

The design and operation of a fuel cartridge module 20, which is suited for integration with overall fuel cell power generation system 10 in FIG. 1, is depicted in detail in FIGS. 2B, 2C and 2D. The permeable flexible bladder can be configured in a cartridge for safe storage of liquid fuel, environmental protection, and orientation independent coupling and operation with an associated fuel cell system. While the bladder can be used with a wide range of liquid fuels, there are additional requirements for formic acid fuel. In the illustrated fuel cartridge 20, housing 22 is preferably a rectangular shape as shown, although cartridge shapes having suitable volume greater than 110% of the filled bladder volume could be employed. Housing 22 is preferably formed substantially leak-free, with sealed joints such as from well-known welding methods, and is of a material non-reactive to formic acid, for example stainless steel. Two openings are provided on housing 22, one for pressure and vacuum release and the other for fuel access, shown for convenience on one side the housing but can be located on a housing surface as suitable for a corresponding cavity (not shown) the cartridge will be fitted to. Fuel port 25 is secured and sealed on an opening and connected to a fuel coupling tube (not shown) attached to the bladder 24. Fuel port 25 is a sealable two-way port such as, for example, a slidable valve coupling that opens when the cartridge is coupled to a matching port, as is commonly known in the art and provided by manufacturers such as BIC. Bladder 24 does not require securing within the housing. Pressure relief valve 28 is secured on the other housing opening, and is designed to relieve pressure above a set-point pressure and has material preferably selected to be non-reactive with formic acid. Exhaust filter 30 is shown covering the pressure relief valve. When the liquid fuel is formic acid the filter 30 is required, and a porous carbon filter can be used suitable for removing CO gas and formic acid vapor. The filter could equivalently be integrated into the pressure relief valve. Pressure relief valve 28 can preferably include vacuum release ability, or a vacuum release valve can be separately attached. The vacuum release valve can be a diffusion barrier membrane.

Stored formic acid fuel in the bladder 24 will naturally evaporate and the formic acid vapor exits the bladder walls, increasing the cavity pressure. The relief pressure setting is selected to keep the internal cavity pressure within a preferred range. In typical use, there is preferably no gas released outside the cartridge, however in extended storage conditions the pressure can exceed the relief pressure setting. The cavity pressure forms an integral function of the passive fuel cartridge, as it pressurizes the bladder fuel sufficient to deliver fuel through the port 25 to the coupled fuel delivery module and fuel cells. Compression elements 26a are shown on the bladder for additional minimum pressurization of the stored fuel. The fuel cartridge has a desired fuel delivery pressure range as determined by the associated fuel cell design and delivery flow path. For the case of formic acid fuel stored in the illustrated bladder, a preferred example of the maximum of this delivery range is 8 pounds per square inch (55.2 kPa); therefore, the pressure relief valve opens at approximately 8 psi (55.2 kPa) pressure to maintain the internal cavity pressure of 8 psi (55.2 kPa) or less. Typically, the pressure maximum for the case of formic acid fuel is 15 psi (103.4 kPa) or less to eliminate explosion risk. Orientation problems due to mixed gas and liquid within the bladder are thereby overcome by the cartridge and bladder combination. Cartridge 20 can be stored or used without regard to orientation, as the permeable bladder and intrinsic and extrinsic pressure on the bladder pushes evaporated gas within the bladder out of the permeable bladder liner such that primarily liquid fuel is contained in the bag, without a significant gas volume, and while maintaining uniform liquid fuel pressure for delivery. Hence, substantially liquid fuel is delivered through the fuel port without being interrupted by gas transfer without regard to orientation, thereby allowing the associated coupled fuel cell operation to be maintained continuously without regard to device orientation. In a preferred case, the coupling tube (not shown) extends inside the bladder approximately halfway to extract a suitable mixture of formic acid fuel. Cartridge 20 of FIGS. 2B, 2C and 2D, is a basic example useful for applications where the fuel cell product gases are separately exhausted and managed by the fuel cell system.

Portable fuel cells are often used to power mobile devices, and should preferably be small in size and integrated within handheld housings. In the case of cell phones, the handheld housing is small and held close to the users head. The cartridge is preferably plugged into the fuel cell ports and hot swappable. A problem is thus created of how to route and filter both fuel cell product exhaust and cartridge released gases within a confined space. A solution is to process the fuel cell system exhaust at the cartridge. To capture the formic acid vapor exiting the cartridge, a fuel cartridge 20 with integrated exhaust management (shown in FIGS. 2B, 2C and 2D) has an port interface cover added to the cartridge for routing and filtering exhaust both from the stored fuel and optionally exhaust from the associated fuel cell system. The fuel cartridge 20 has the same two openings and fuel port 25 and relief valve 28. Port interface cover 22b is preferably covering one side of the cartridge housing 22 and preferably planar for coupling to a mating surface to the associated fuel cell system shown in FIG. 2A, but can be split on more than one side or cover a portion of a side or have non-planar portions provided the functions of the interface cover as described herein are still provided. An opening 33 is provided in the outward mating surface of the port interface for exhausting byproducts. A second opening 35 is provided as shown in top view, which is larger than fuel port 25 and sufficient to allow exhaust from the fuel cell system to be transferred through the gap around the fuel port 25. Second opening 25 is preferably surrounded by a compression seal perimeter such that when the cartridge is coupled to the associated fuel cell system the fuel port is coupled to a corresponding fuel inlet port and the gap surrounding fuel port 25 is coupled to a matching fuel cell exhaust port 91 such that the fuel port coupling is sealed and the fuel cell exhaust port is sealed to the interface port. The internal form of the port interface 22b is shown in the cross section view. An exhaust filter 30 is tightly fitted within a cavity below the exhaust opening 33, such that exhaust flows through and not around the filter to reach the exhaust opening 33. An internal cavity covers the pressure relief valve 28 and includes the fuel cell exhaust opening surrounding port 25. The internal cavity is connected to the filter and exhaust opening through a small passage gap as illustrated. Stored fuel out gassing escaping the pressure relief valve is forced to traverse the filter and exit with hazardous byproducts such as CO removed. Similarly fuel cell exhaust enters the port interface through the gap surrounding fuel port 25 and is forced to traverse the same path through the filter to remove hazardous byproducts such as CO, H₂COOH, and the like. In a preferred embodiment, the port interface cover is secured to the housing 22 to provide an excellent seal; however, in an alternate embodiment, the port interface cover 22b is removable such that the filter can be replaced when depleted. The fuel cartridge, as shown, requires no latching or locking attachments to the housing, and is coupled such that the cartridge is pushed in a fitted cavity and the port interface slides against a matching surface and the fuel port 25 is press-fit to a corresponding fuel port 41 of the fuel cell system securing the fuel cartridge to the mating cavity sufficient to withstand typical handling forces and drops without releasing or impacting fuel delivery. Fuel cartridge 20 can be released by manually sliding it out of a device cavity (not shown).

Passive Fuel Delivery Module

The fuel delivery module functions primarily to route the fuel and to control the fuel dose volume, and requires a fuel pressure differential between the fuel cell conduit and the bladder fuel pressure. As shown in FIG. 1, fuel delivery module 40 includes a fuel delivery module inlet 41 fluidly connected to cartridge liquid fuel stream port 21. Inlet 41 has a sealable valve 42 that mates with sealable valve 25 of cartridge module 20, and like cartridge valve 25 accommodates bidirectional flow of liquid fuel stream into and out of said cartridge module 20. Fuel delivery module outlet 50, shown in FIG. 1 as a branched manifold, discharges a liquid fuel stream suitable for electrocatalytic conversion in fuel cell module 60 to cations and reaction product. A fuel valve 150 is interposed in fuel delivery conduit 43 for controlling the dose of liquid fuel stream 23 between fuel delivery module inlet 41 and fuel delivery module outlet 50, in response to the microcontroller connected at 151. A recycle liquid fuel stream inlet 53 is fluidly connected to fuel delivery conduit 43 at a junction between fuel delivery module inlet 41 and valve 150. An optional particulate filter is interposed in fuel delivery conduit 43 between junction 53 and valve 150.

In the case where fuel cell module 60 includes two or more electrochemical fuel cells, as shown in FIG. 1, in which fuel cell module 60 employs five fuel cells 62a, 62b, 62c, 62d and 62e, fuel delivery module outlet 50 preferably takes the form of a branched manifold for directing discharged liquid fuel stream 23 to the fuel cell anodes, one of which is shown in FIG. 1 as anode 64a, through a plurality of restricting orifices 50a, 50b, 50c, 50d and 50e. Discharged liquid fuel stream 23 is thereby distributed substantially evenly among the anodes of fuel cells 62a, 62b, 62c, 62d and 62e.

As shown in FIG. 1, a check valve 91 is interposed between exhaust stream outlet 83 and junction 53, thereby restricting flow of recycle liquid fuel stream in the direction from exhaust stream outlet 83 to junction 53.

Fuel Cell Module

Fuel cell module 60 includes one or more electrochemical fuel cells, shown in FIG. 1 as five fuel cells 62a, 62b, 62c, 62d and 62e. Each fuel cell includes an anode, one of which is shown in FIG. 1 as anode 64a, for promoting electrocatalytic conversion of at least a portion of liquid fuel stream 43a discharged from branched manifold outlet 50 of fuel delivery module 40 to cations and an anode exhaust stream 67a. Similarly, the anodes of each of fuel cells 62b, 62c, 62d and 62e promote electrocatalytic conversion of at least a portion of liquid fuel streams 43b, 43c, 43d and 43e, respectively, discharged from branched manifold outlet 50 of fuel delivery module 40 to cations and anode exhaust streams 67b, 67c, 67d and 67e, respectively. Anode exhaust streams 67a, 67b, 67c, 67d and 67e comprise un-reacted fuel stream constituents and anode reaction product. In the case of an aqueous formic acid fuel stream, the anode reaction product would include water, carbon dioxide and a trace amount of carbon monoxide.

Each of fuel cells 62a, 62b, 62c, 62d and 62e also includes a cathode, one of which is shown in FIG. 1 as cathode 64c, for promoting electrocatalytic reaction of cations formed at the fuel cell anodes with an oxidant stream directed to the cathodes. The cathodes of fuel cells 62a, 62b, 62c, 62d and 62e are electrically connected to the anodes of fuel cells 62a, 62b, 62c, 62d and 62e through a circuit 69 having an electrical load (shown as load 136 of power management module 120, and explained in more detail below) interposed in circuit 69. Electrons generated at the anodes of fuel cells 62a, 62b, 62c, 62d and 62e are drawn to the cathodes through circuit 69 to drive load 136 and a cathode exhaust stream 67 is produced. Cathode exhaust stream 67 is the exhaust stream consolidated from the individual fuel cell cathode exhaust streams 67a, 67b, 67c, 67d and 67e.

In each of fuel cells 62a, 62b, 62c, 62d and 62e, a cation exchange membrane, one of which is shown in FIG. 1 as cation exchange membrane 64b, is interposed between each anode (one of which is shown in FIG. 1 as anode 64a) and each cathode (one of which is shown in FIG. 1 as cathode 64c). Cation exchange membrane facilitates the migration of cations (also referred to as protons or hydrogen ions) from anode electrocatalytic reaction sites to cathode electrocatalytic reaction sites.

The passive pumping fuel cell system is operable with a wide range of fuel cell designs for local fuel distribution at the anode. It is generally preferred to have a uniform local fuel distribution, such that a fuel distribution layer uniformly and locally distributes fuel with the fuel cell without regard to orientation, and a reduction in effective fuel concentration at the anode surface such that a highly concentrated fuel can be used with high energy storage density. When the fuel cell module 60 of passive pumping fuel cell system 10 incorporates the referenced fuel distribution layer at the anode, the entire system 10 becomes orientation independent providing uniform fuel delivery and operation without regard to orientation, representing a substantial advance over known designs. Alternate local distribution layers can be substituted such as a fuel wick but are less preferred.

Exhaust Module

Exhaust module 80 includes an exhaust module inlet 81 for receiving consolidated fuel cell anode exhaust stream 67 and an exhaust module outlet 83 fluidly connected to fluid delivery module recycle liquid fuel stream inlet 53. A gas-liquid separator 82 is interposed between exhaust module inlet 81 and said exhaust module outlet 83.

Gas-liquid separator 82 includes a first chamber 82a and a second chamber 82b. First chamber 82a includes an inlet 85 for admitting anode exhaust stream 67 into first chamber 82a and an outlet 83 for discharging a recycle liquid fuel stream 87. Exhaust module 80 preferably includes a particulate filter 88 interposed in recycle liquid fuel stream 87 discharged from gas-liquid separator first chamber outlet 83. Second chamber 82b includes an outlet 93 for discharging a gaseous exhaust stream 89.

A gas-liquid separator membrane 82c is interposed between first chamber 82a and second chamber 82b of gas-liquid separator 82, and when completely blocked with liquid acts as a passive shutoff valve. Separator membrane 82c permits diffusion of at least a portion of the gaseous exhaust stream constituents present in anode exhaust stream 67, from first chamber 82a to second chamber 82b. Vapor permeable polytetrafluoroethylene liners can be used. Gaseous exhaust stream 89 is discharged from second chamber 82b. The gas-liquid separator is configured to provide the following functions for the case of formic acid fuel: from an intake of dilute formic acid and CO₂, CO₂ passes across the membrane, thereby creating a pressure differential that is proportional to fuel flow rate through the fuel cell anode passages. The dilute formic acid liquid is collected, without regard to system orientation, next to a drain trap check valve, which when open requires the liquid to escape before gas is recycled. Following liquid transfer to the bladder, gas is recycled back into the bladder, to the cartridge interior, thereby restoring cartridge pressure for fueling mode.

One or more vapor cells, which in system 10 of FIG. 1 consists of a single vapor cell 84, consumes and electrocatalytically converts a vaporous fuel stream discharged from a chamber of gas-liquid separator 82 to benign reaction product, as explained in more detail below.

An optional vapor cell 84 can be included in the exhaust module in series with the gas-liquid separator, to reduce fuel in the vapor from the separator. This is beneficial in the case of formic acid fuel, if the cartridge filter has saturated and reduced ability to filter the byproducts. The vapor cell 84 has a configuration that is substantially identical to fuel cells 62a, 62b, 62c, 62d and 62e, and includes an anode 84a, which is fluidly connected to gas-liquid separator second chamber outlet 93. Vapor cell anode 84a promotes electrocatalytic conversion of at least a portion of gaseous exhaust stream 89 to cations and a vapor cell anode exhaust stream 97. Vapor cell anode exhaust stream 97 includes un-reacted constituents from gaseous exhaust stream 89, if any, and vapor cell anode reaction product.

Vapor cell 84 also includes a cathode 84c for promoting electrocatalytic reaction of cations produced at vapor cell anode 84a with an oxidant stream (depicted as oxygen (O2) from air in FIG. 1) directed to vapor cell cathode 84c. A cation exchange membrane 84b is interposed between vapor cell anode 84a and vapor cell cathode 84c. Vapor cell cathode 84c is electrically connected to vapor cell anode 84a through a circuit 87 that includes an electrical load (shown in FIG. 1 as a switch 87 for shorting circuit 87). Electrons are thereby drawn from vapor cell anode 84a to vapor cell cathode 84c through circuit 87 and a vapor cell cathode exhaust stream 97 is produced.

Moisture Management Module

Additionally, moisture management can optionally be included, if the application requires it. As shown in FIG. 1, moisture management module 100 includes a water-absorbing wick layer 102 in fluid contact with the cathodes of fuel cells 62a, 62b, 62c, 62d and 62e, one cathode of which is illustrated in FIG. 1 as cathode 64c. Wick layer is also preferably in fluid contact with vapor cell cathode 84c.

An air plenum 106 in fluid contact with wick layer 102 directs an air stream over wick layer 102 such that at least some of the water generated at fuel cell cathode 64c and the other fuel cell cathodes, as well as at least some of the water generated at vapor cell cathode 84c is drawn away and evaporated into the air stream directed through plenum 106. A passive air filter 104 is preferably interposed between wick layer 102 and air plenum 106. As further shown in FIG. 1, an air stream is directed over wick layer 102 by an air plenum fan 108, the flow of which is controlled by a signal 125a generated by a microcontroller in power management module 120, as described in mode detail below. A pair of water barrier membranes 110a, 110b cover opposing ends of air plenum 106, as shown in FIG. 1. Water barrier membranes 110a, 110b are permeable to gaseous streams and substantially impermeable to liquid water.

Power Management Module

As further shown in FIG. 1, a power management module 120 is electrically connected to one or more of fuel cartridge module 20, fuel delivery module 40, fuel cell module 60, exhaust module 80 and moisture management module 100. Power management module 120 includes an electrical energy storage device 130, shown in FIG. 1 as a storage battery, interposed between fuel cell module 40 and electrical load 136. Storage device 130 receives, stores and delivers electrical energy generated by fuel cell module 40 to load 136. Power management module 120 also includes a microcontroller 122 capable of regulating charging of storage device 130 by fuel cell module 40. Storage device 130 could alternatively and/or additionally include capacitor or other like electrical device for receiving, storing and delivering electrical energy.

As further shown in FIG. 1, power management module 120 can also include a fan control device 124, in turn electrically connected to and responsive to microcontroller 122, for regulating, via signal 125a, flow of the air stream directed by fan 108 through plenum 106 in moisture management module 100.

Power management module 100 can also include a cell voltage monitor electrically connected to and/or integral with microcontroller 122. The cell voltage monitor is capable of directing electrical signals to microcontroller 122 in response to voltage variations across fuel cells 62a, 62b, 62c, 62d and 62e. Microcontroller 122 is also capable of effectuating operational changes via electrical signals, one of which is depicted in FIG. 1 as signal 123a, directed to one or more of fuel delivery module 40, fuel cell module 60, exhaust module 80 and moisture management module 100 in response to such voltage variations.

As illustrated in FIG. 1, power management module 120 includes a valve control device 126 responsive to microcontroller 122 via signal circuit 127. A power conditioning device 128 is in series with re-activating boost device 134 via circuit 69 interconnecting the fuel cell anodes and fuel cell cathodes. Re-activating boost device 131 is in turn responsive to power management device 132 via signal circuit 131, for the purpose of applying potential to fuel cells for membrane re-activation, and is optional for the operation of the passive pumped fuel cell system. Power management device 134 in turn regulates the charging of electrical energy storage device 130 (battery cells in FIG. 1) by fuel cell module 60, and also directs electric power to electrical load 136 via circuit 133.

System Operation

System 10 is especially well-suited to vaporizable liquid fuels capable of electrocatalytic conversion in direct liquid feed fuel cells. Preferred fuels include vaporizable liquid organic compositions capable of electrocatalytic conversion in direct liquid feed fuel cells, especially those in which vapor cell anode exhaust stream 97 contains carbon dioxide. System 10 is particularly well-suited to formic acid, more particularly an aqueous formic acid solution, which is a vaporizable liquid organic composition capable of electrocatalytic conversion to protons, carbon dioxide and water in anodes of direct liquid feed fuel cells. The present system enables recycling of un-reacted formic acid in liquid form back to the stored fuel, while vaporous fuel present in the anode exhaust stream is separated from liquid formic acid in a gas-liquid separator, and the vaporous fuel is then returned to the cartridge where it is filtered prior to exhaust as substantially benign carbon dioxide. Thus the formic acid fuel cycles within the closed system in liquid form, excepting where it is reacted or vapor byproducts filtered and exhausted. Passive circulation of fuel should maintain a pressure differential between the stored liquid fuel in the bladder and remaining fuel in the anode chamber of the fuel cell in series with the gas-liquid separator. The operation will be discussed with respect to these pressures.

Flexible bladder 22 contains a liquid fuel such as aqueous formic acid. Typically the bladder would start filled to its maximum expansion, resulting in about 90% of the cartridge interior volume. Inlet/outlet port 25 is fluidly connected to bladder 24. Port 25 intermittently discharges and admits a pressurized fuel stream 25 from and to bladder 24.

As further shown in FIG. 1, fuel cell module 40 includes four electrochemical fuel cells 42a, 42b, 42c and 42d. Each of fuel cells 42a, 42b, 42c and 42d includes an anode 44, a cathode 46, and a cation exchange membrane 48 interposed between anode 44 and cathode 46. As shown in FIG. 1, anode 44 is fluidly connected to fuel delivery module outlet 36. Anode 44 promotes electrocatalytic conversion of at least a portion of pressurized fuel stream 25 to cations and an anode exhaust stream 49. Anode exhaust stream 49 includes un-reacted fuel stream constituents (if any) and anode reaction products. In the case of pressurized fuel stream 25 being dead-ended at each of anodes 42a, 42b, 42c and 42d, there would be no un-reacted fuel stream constituents. When the liquid fuel is formic acid, the anode reaction products include CO₂ and CO.

The cartridge illustrated in FIGS. 2B, 2C and 2D, provides fuel delivery and fuel and byproduct return functionality when coupled to the fuel cell system of FIG. 1. It is instructive to consider pressure in three regions, P1 within the housing cavity, P2 bladder fuel pressure and P3 fuel cell pressure of the fuel cell fuel line 43 downstream of fuel valve 150. The gas pressure in the housing cavity P1 results from fuel vapor permeating the bladder. The internal bladder fuel pressure P2 is proportional to the summed pressures from elastomeric members 60 and internal cavity pressure P1. Fuel pressure at the anode of the fuel cell, is a function of fuel utilization rate, dose volume, and backpressure from the gas-liquid separator, which is connected to the anode fuel cell outlet. Fuel can be exchanged between the cartridge and fuel cell system by controlling this differential pressure, as will be described.

Delivery of liquid fuel from the cartridge bladder 24 to the fuel cell anode 67 is enabled when the internal bladder fuel pressure P2 is greater than the fuel line pressure P3. The cartridge is pressurized with primarily CO₂ when the stored fuel is formic acid fuel and inert gas such as air drawn in by the vacuum relief valve. Fuel is passively delivered from bladder to fuel cell, when the fuel valve 150 is opened by the controlled for a duration selected to provide a fuel dose to each fuel cell, appropriate for the cell volume and reaction rate necessary or desirable for the load, and can be customized based on cell voltage feedback. Fuel fills the cells saturating the anode fluidic reservoir described for the preferred case. The pressure differential can be controlled by lowering or relieving the current draw from the fuel cells, which decreases fuel cell line pressure as CO₂ exhaust flow drops. Note this passive fueling only requires controlling a single valve with low parasitic power, and no pumps or powered actuators. It is instructive to review the change in pressure P2 with time. As described previously, when the liquid fuel is initially stored in the bladder, the compression elements 26a provide a minimal pressure differential for fueling, and as pressure P1 builds up within the housing, additional pressure contribution is added.

With respect to recycling there are three inter-related fluid transfers from the resulting fuel cell operation. First, separated exhaust gas is released through the cartridge filter and expelled. Second, excessive exhaust CO₂ pressure is created when the gas-liquid separator is full and “shut-off” and the fuel cell is operated in high current mode, resulting in a backpressure flowing into the cartridge bladder which then migrates through the bladder liner to the interior cavity pressurizing the bladder. Third, unused liquid fuel is forced by the increased CO₂ pressure to be pushed through the check valve 52 and into the cartridge bladder to maintain bladder volume.

Separated exhaust gas traverses conduit 89 through to fuel cell exhaust port 91 (and through optional vapor cell 84 if included). When the cartridge is coupled to the fuel cell system, port 91 is opened, releasing the exhaust gas to traverse a passage through to filter 30 where CO₂ is removed and the remainder exhausted to ambient. The pressure differential in this case only has to be above ambient to exhaust the gas.

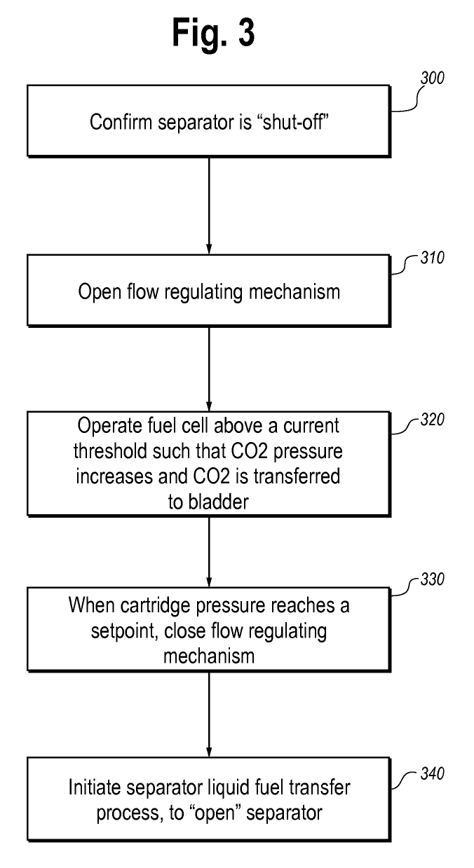

The method of returning gas to the bladder in the cartridge is described in FIG. 3. As the fuel cell system continues operating, unused liquid fuel builds up in the gas-liquid separator reaching a full state where the second separator chamber is full and the separator is “shut-off” meaning no further gas or liquid can be transmitted (step 300), until the liquid is pressurized above check valve 52 pressure setpoint. At this stage controller 122 triggers a high current fuel cell mode generating excess CO₂ for a short duration (step 320). This excess CO₂ results in a backpressure that builds up through the anode and conduit 43 to the manifold 50 to fuel flow regulating mechanism 150 which is opened by valve control 126 (step 310), to allow flow back into the bladder and through the permeable bladder liner to the cartridge interior. A pressure transducer (not shown) monitors the cartridge pressure and closes flow-regulating mechanism when the cartridge pressure is high enough for subsequent fueling (step 330). If returned to a conventional impermeable bladder, the returned gas would create a pocket in the liquid and the cartridge would no longer be orientation independent. This mode allows the pressure to be increased in the cartridge back to levels necessary or desirable for adequate fuel dosing. Step 340 can be done in sequence or later, to initiate the process to push the trapped liquid fuel from the separator.

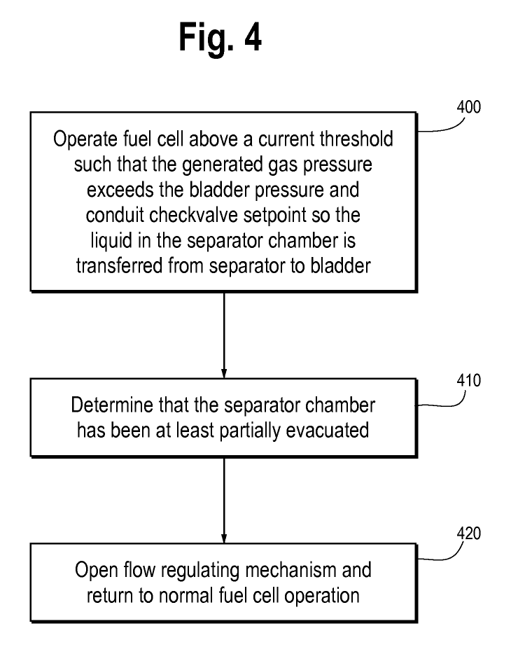

The third transfer mode can be termed liquid fuel recycling in that unused liquid fuel which is forced by the increased CO₂ pressure to be pushed through the check valve 52 and into the cartridge bladder to maintain bladder volume, since it remains in the bladder, and the method is described in FIG. 4. The passive pumped fuel cell system 10, can operate in a liquid fuel return mode for returning depleted or partially used formic acid fuel (and water byproducts from the fuel cell operation) from the gas-liquid separator 85 back to the bladder 24 through the conduits described in FIG. 1, where it is mixed with original fuel. As further shown in FIG. 1, fuel delivery module 40 includes an inlet/outlet port 41, an outlet 50, a pressurized fuel stream conduit 43 interconnecting inlet/outlet port 41 and outlet 50, and a recycle fuel stream conduit 87 for directing a recycle fuel stream 87 from gas liquid separator 85 to fuel stream conduit 43 when check valve 52 is opened. Typically, unused fuel is returned following the second transfer mode described, and the CO₂ gas in the anode fuel cell lines has increased such that switch 150 is now closed, and the unused fuel does not flow directly to the fuel cell. The return of unused fuel to the cartridge serves two purposes, first to provide a closed system for the fuel within the confined system space, and secondly to be used to periodically replace the lost fuel volume for maintaining bladder fuel pressure P2 suitable for delivering fuel. Depleted fuel typically is partially separated and can still contain both liquid and some fractional gas. If returned to a conventional impermeable bladder, the returned gas would create a pocket in the liquid and the cartridge would no longer be orientation independent. However, in the present passive pumped fuel cell system, the depleted liquid fuel is returned when the pressure P3 caused by the excess CO₂ generation (and which is in equilibrium with the pressure of the liquid trapped in separator 85) exceeds the bladder pressure P2 and check valve 52 setpoint. Essentially, the separated liquid collects at the separator 85, increasing in pressure until it inhibits further fuel delivery and shuts down the separator. At this point, the fuel cell system can alternatively return fuel by suitable methods that increase the separated depleted fuel pressure above the bladder fuel pressure, including the use of pumps. The preferred method, without requiring extra components, is the described high current fuel cell operation (such as created by a shorted load) (step 400) such that excess gas byproducts are generated at the anode creating additional pressure on the membrane and liquid in the gas-liquid separator such that P3>P2 and the separated fuel is pushed back into the cartridge bladder 24 (step 410). Such a shorted mode could be provided by a fuel cell re-activation or regeneration circuit as shown in FIG. 1. It will be appreciated that the third transfer mode of recycling liquid fuel can be selected independent of the second transfer mode of returning gas to the bladder. Further, the load and resulting rate of generating CO₂ can be different for the second and third modes, preferably the third mode has a higher load or “burst” mode of high current operation. Following step 410, the controller 122 returns the system to normal operation by opening the flow regulating mechanism (step 420).

The formic acid fuel stored in the bladder is diluted by the returned depleted fuel, however, many return fuel cycles can be performed to maintain passive fuel pumping, before the formic acid concentration (by weight) is reduced below a usable threshold. For example, the initial fuel can start at 70% by weight formic acid, and through multiple fuel returns can be reduced to 20% by weight formic acid, at which threshold the cartridge requires refueling. Alternatively the cartridge can optionally include a sensor(not shown) responsive to the formic acid concentration in the bladder, for example a visual indicator or chemical strip indicating when concentration is too low. Preferably the associated fuel cell system is discontinuously operable by the controller 122, to allow for switching between delivery and return conditions. A fuel cell system for discontinuous hybrid battery charging would be appropriate, as shown in FIG. 1.

In operation, when flow regulating mechanism 150 is in an open position and the pressure in the bladder exceeds the fuel cell pressure, pressurized fuel stream is discharged from cartridge module 20 into fuel cell module 60. When flow regulating mechanism 150 is in a closed position, recycle fuel stream 37 can be returned into cartridge module 20, when the pressure differential P3>P2 exists. When gas-liquid separator is in “shut-off” mode, a sensor (not shown) can provide a signal to the flow-regulating mechanism to open to allow the backpressure of CO₂ to enter the cartridge bladder, or alternatively the flow-regulating mechanism 150 can have an integrated check valve (not shown) to allow backpressure flow above a set-point pressure.

In operation of system 10 with the optional vapor cell, vaporous fuel in anode exhaust stream 89 is converted in vapor cell 84 to substantially benign vapor cell anode reaction product and un-reacted gaseous exhaust stream constituents, if any. Such un-reacted gaseous exhaust stream constituents are then directed through cartridge filter 30, where they are trapped and a benign exhaust stream is discharged from cartridge module 20. The optional vapor cell assists when the cartridge filter has expired or alternatively the rate of excess unused fuel exceeds the capability of the gas-liquid separator to process it and an optional bypass conduit (not shown) could be included.

The advantages of the present passive-pumping liquid feed fuel cell system include replacing wicking systems, active suction pumps, or bulky mechanical springs commonly used in delivering fuel from a cartridge, by utilizing the unique vaporizable properties of liquid fuels such as formic acid. Also, providing a closed liquid fuel circuit for storing and reusing unused fuel, by passively pumping unused fuel back into the cartridge. Providing a method of maintaining delivered fuel pressure differential in a precise and controlled range for micro-dosing fuel in low power applications, results in improved overall efficiency. The overall number and complexity of required components in the fuel cell system, by integrating functions between a cartridge and a fuel cell system. Most importantly, the embodiments described allow continuous operation of the fuel cell without regard to user orientation.

While particular elements, embodiments and applications of the present invention have been shown and described, it will be understood, of course, that the invention is not limited thereto since modifications can be made by those skilled in the art without departing from the scope of the present disclosure, particularly in light of the foregoing teachings.

What is claimed is:

1. A passive-pumping liquid feed fuel cell system comprising:
(a) a cartridge module comprising:
(1) a cartridge housing having an interior cavity and an exterior surface;
(2) a cartridge liquid fuel stream port encompassed by said housing exterior surface and having a sealable valve accommodating bidirectional flow of said liquid fuel stream into and out of said cartridge module;
(3) a bladder disposed within said interior cavity and capable of storing, delivering and receiving a quantity of said liquid fuel stream;
(4) a compression mechanism for imparting at least a minimal positive fluid pressure to said bladder;
(5) a pressure relief valve for discharging a gaseous stream from said cartridge housing at a set pressure; and
(6) a vacuum relief valve for drawing a gaseous stream into said interior cavity to inhibit formation of a vacuum within said cartridge housing;
(b) a fuel delivery module comprising:
(1) an inlet/outlet port for intermittently admitting and discharging said pressurized fuel stream to and from said fuel delivery module, respectively, said fuel delivery module inlet/outlet port capable of cooperating with said cartridge module inlet/outlet port to inhibit leakage of said intermittently admitted and discharged pressurized fuel stream;
(2) a fuel delivery module outlet for discharging at least a portion of said pressurized fuel stream from said fuel delivery module;
(3) a pressurized fuel stream conduit interconnecting said fuel delivery module inlet/outlet port and said fuel delivery module outlet, said pressurized fuel stream conduit having a flow regulating mechanism interposed therein for allowing flow in said pressurized fuel stream conduit when said flow regulating mechanism is in an open position and inhibiting flow in said pressurized fuel stream conduit when said flow regulating mechanism is in a closed position;
(4) a recycle fuel stream conduit for directing a recycle fuel stream from a fuel delivery module recycle fuel stream inlet to said pressurized fuel stream conduit at a junction located between said fuel delivery module fuel stream port and said flow regulating mechanism, said recycle fuel stream conduit having a pressure-activated mechanism disposed therein for inducing flow between said recycle fuel stream inlet and said junction;
(c) a fuel cell module comprising at least one electrochemical fuel cell comprising:
(1) an anode fluidly connected to said fuel delivery module outlet, said anode promoting electrocatalytic conversion of at least a portion of said pressurized fuel stream to cations and an anode exhaust stream, said anode exhaust stream comprising unreacted fuel stream constituents, if any, and anode reaction products;
(2) a cathode for promoting electrocatalytic reaction of said cations with an oxidant stream directed to said cathode, said cathode electrically connected to said anode via a circuit comprising an electrical load, whereby electrons are drawn from said anode to said cathode via said circuit and a cathode exhaust stream is produced;
(3) a cation exchange membrane interposed between said anode and said cathode;
(d) an exhaust module comprising:
(1) an exhaust module inlet for receiving said anode exhaust stream;
(2) an exhaust module outlet fluidly connected to said fuel delivery module recycle fuel stream inlet;
(3) a gas-liquid separator interposed between said exhaust module inlet and said exhaust module outlet, said separator comprising:
(i) a first chamber comprising an inlet for admitting said anode exhaust stream into said first chamber and an outlet for discharging said recycle fuel stream from said first chamber to said fuel delivery module recycle fuel stream inlet,
(ii) a second chamber comprising an exhaust module outlet for discharging a gaseous exhaust stream comprising at least some of said unreacted fuel stream constituents, if any, and at least some of said anode reaction products, and
(iii) a gas-liquid separator membrane interposed between said first chamber and said second chamber, said separator membrane capable of allowing diffusion of at least a portion of said gaseous exhaust stream constituents from said first chamber to said second chamber;
whereby, when said fuel delivery module flow regulating mechanism is in an open position, said pressurized fuel stream is discharged from said cartridge module, and when said fuel delivery module flow regulating mechanism is in a closed position, said recycle fuel stream is admitted into said cartridge module.

2. The system of claim 1, wherein said fuel delivery module inlet/outlet port and said cartridge module inlet/outlet port are removably connected.

3. The system of claim 1 further comprising a fuel manifold for containing a quantity of said pressurized fuel stream, said fuel manifold interposed in said pressurized fuel stream conduit between said flow-regulating mechanism and said fuel delivery module outlet.

4. The system of claim 3, wherein said at least one fuel cell comprises a plurality of fuel cells, each of said fuel cell anodes in direct fluid communication with said fuel delivery module outlet.

5. The system of claim 3, wherein said at least one fuel cell comprises a plurality of fuel cells, a first one of said fuel cell anodes in direct fluid communication with said fuel delivery module outlet, said first anode exhaust stream directed to at least one other of said fuel cell anodes.

6. The system of claim 5, wherein said at least one fuel cell comprises at least three fuel cells in cascaded fluid communication such that a first one of said fuel cell anodes is in direct fluid communication with said fuel delivery module outlet, said first anode exhaust stream is directed to a second one of said fuel cell anodes, said second one of said fuel cell anode exhaust streams is directed to a third one of said fuel cell anodes, and each further one of said fuel cell anode exhaust streams is directed to a remaining one of said fuel cell anodes.

7. The system of claim 3 further comprising an anode exhaust manifold for containing a quantity of said anode exhaust stream, said anode exhaust manifold interposed between said at least one fuel cell and said gas-liquid separator.

8. The system of claim 1, wherein said exhaust module further comprising a filter interposed between said at least one fuel cell and said gas-liquid separator, said filter inhibiting the passage of particles entrained in said anode exhaust stream.

9. The system of claim 1, wherein said cartridge module further comprises a filter capable of entrapping carbon monoxide.

10. The system of claim 1, wherein said cartridge module further comprises a filter capable of entrapping vaporous fuel emitted from said bladder.

11. The system of claim 10, wherein said filter is further capable of entrapping carbon monoxide.

12. The system of claim 10, wherein said bladder is formed of semi-permeable material to facilitate diffusion of vaporous fuel from said bladder.

13. The system of claim 1, wherein said bladder is formed of material capable of inhibiting water condensation.

14. The system of claim 10, wherein said cartridge module further comprises a pressure relief mechanism fluidly associated with said bladder, said pressure relief mechanism actuatable to discharge an exhaust fluid stream from said bladder when a predetermined pressure magnitude within said bladder is attained, said exhaust fluid stream directed to said vapor filter.

15. The system of claim 10, wherein said cartridge module further comprises an outlet fluidly connected to said filter for discharging an exhaust fluid stream from said cartridge module.

16. The system of claim 10, wherein said exhaust module further comprises a vapor cell having a first inlet for admitting into said exhaust module vapor cell at least a portion of said gaseous exhaust stream discharged from said gas-liquid separator second chamber and a second inlet for admitting into said exhaust module vapor cell an oxidant stream, said vapor cell producing an exhaust module gaseous contaminant stream discharged from a first outlet and a benign vapor discharge stream discharged from a second outlet, said vapor cell first outlet fluidly connected to said cartridge module vapor filter.

17. The system of claim 1, wherein said liquid fuel is organic.

18. The system of claim 1, wherein said liquid fuel comprises formic acid

19. The system of claim 18, wherein said liquid fuel is an aqueous solution comprising formic acid.

20. The system of claim 19, wherein said aqueous formic acid solution has a concentration of 10-90% formic acid by weight.

21. The system of claim 1, wherein said cartridge module further comprises a compression mechanism operatively associated with said bladder for pressurizing liquid fuel contained in said bladder.

22. The system of claim 21, wherein said compression mechanism is at least partially mechanically actuated.

23. The system of claim 22, wherein said compression mechanism comprises at least one elastomeric member.

24. The system of claim 23, wherein said compression mechanism comprises a plurality of elastomeric members circumscribing said bladder.

25. The system of claim 22, wherein said compression mechanism comprises at least one spring.

26. The system of claim 1, wherein said cartridge module has an exterior surface capable of being removably latched to a housing containing at least one of said fuel delivery module, said fuel cell module and said exhaust module.

27. The system of claim 1, wherein said cartridge module has a deformable exterior surface capable of being press-fitted into a cavity formed in a housing containing at least one of said fuel delivery module, said fuel cell module and said exhaust module.

28. The system of claim 18, wherein said cathode exhaust stream comprises water and wherein said fuel cell module has a wicking material fluidly connected to said cathode for drawing liquid water entrained in said cathode exhaust stream away from said cathode.

29. The system of claim 18 further comprising an evaporative surface fluidly connected to said wicking material for promoting evaporation of said entrained liquid water into a surrounding atmosphere.

30. A passive-pumping liquid feed fuel cell system couplable to a cartridge module having a cartridge housing having an interior cavity and an exterior surface, a cartridge liquid fuel stream port encompassed by said housing exterior surface and having a sealable valve accommodating bidirectional flow of said liquid fuel stream into and out of said cartridge module, a bladder disposed within said interior cavity and capable of storing, delivering and receiving a quantity of said liquid fuel stream, a compression mechanism for imparting at least a minimal positive fluid pressure to said bladder, a pressure relief valve for discharging a gaseous stream from said cartridge housing at a set pressure; and a vacuum relief valve for drawing a gaseous stream into said interior cavity to inhibit formation of a vacuum within said cartridge housing, said system comprising:
(a) a fuel delivery module couplable to said cartridge, comprising:
(1) an inlet/outlet port for intermittently admitting and discharging said pressurized fuel stream to and from said fuel delivery module, respectively, said fuel delivery module inlet/outlet port capable of cooperating with said cartridge module inlet/outlet port to inhibit leakage of said intermittently admitted and discharged pressurized fuel stream;
(2) a fuel delivery module outlet for discharging at least a portion of said pressurized fuel stream from said fuel delivery module;
(3) a pressurized fuel stream conduit interconnecting said fuel delivery module inlet/outlet port and said fuel delivery module outlet, said pressurized fuel stream conduit having a flow regulating mechanism interposed therein for allowing flow in said pressurized fuel stream conduit when said flow regulating mechanism is in an open position and inhibiting flow in said pressurized fuel stream conduit when said flow regulating mechanism is in a closed position;
(4) a recycle fuel stream conduit for directing a recycle fuel stream from a fuel delivery module recycle fuel stream inlet to said pressurized fuel stream conduit at a junction located between said fuel delivery module fuel stream port and said flow regulating mechanism, said recycle fuel stream conduit having a pressure-activated mechanism disposed therein for inducing flow between said recycle fuel stream inlet and said junction;
(b) a fuel cell module comprising at least one electrochemical fuel cell comprising:
(1) an anode fluidly connected to said fuel delivery module outlet, said anode promoting electrocatalytic conversion of at least a portion of said pressurized fuel stream to cations and an anode exhaust stream, said anode exhaust stream comprising un-reacted fuel stream constituents, if any, and anode reaction products;
(2) a cathode for promoting electrocatalytic reaction of said cations with an oxidant stream directed to said cathode, said cathode electrically connected to said anode via a circuit comprising an electrical load, whereby electrons are drawn from said anode to said cathode via said circuit and a cathode exhaust stream is produced;
(3) a cation exchange membrane interposed between said anode and said cathode;
(c) an exhaust module comprising:
(1) an exhaust module inlet for receiving said anode exhaust stream;
(2) an exhaust module outlet fluidly connected to said fuel delivery module recycle fuel stream inlet;
(3) a gas-liquid separator interposed between said exhaust module inlet and said exhaust module outlet, said separator comprising:
(i) a first chamber comprising an inlet for admitting said anode exhaust stream into said first chamber and an outlet for discharging said recycle fuel stream from said first chamber to said fuel delivery module recycle fuel stream inlet,
(ii) a second chamber comprising an exhaust module outlet for discharging a gaseous exhaust stream comprising at least some of said un-reacted fuel stream constituents, if any, and at least some of said anode reaction products, and
(iii) a gas-liquid separator membrane interposed between said first chamber and said second chamber, said separator membrane capable of allowing diffusion of at least a portion of said gaseous exhaust stream constituents from said first chamber to said second chamber;
whereby, when said fuel delivery module is coupled to said cartridge, and when said flow regulating mechanism is in an open position, said pressurized fuel stream is discharged from said cartridge module, and when said fuel delivery module flow regulating mechanism is in a closed position, said recycle fuel stream is admitted into said cartridge module.
